(19) United States
(12) Patent Application Publication
(10) Pub. No.: US 2017/0008571 A1
(43) Pub. Date: Jan. 12, 2017

(54) ADAPTIVE ENERGY ABSORBING FLOORING SYSTEM

(71) Applicant: Gregory Hiemenz, Silver Spring, MD (US)

(72) Inventor: Gregory Hiemenz, Silver Spring, MD (US)

(21) Appl. No.: 15/205,135

(22) Filed: Jul. 8, 2016

Related U.S. Application Data
(60) Provisional application No. 62/189,778, filed on Jul. 8, 2015.

(51) Int. Cl. B62D 25/20; B60R 21/12; F41H 7/04; B62D 21/15

(52) U.S. Cl. CPC B62D 25/20; B62D 21/15; B60R 21/12; F41H 7/042

(57) ABSTRACT

A protective flooring system for a vehicle having a base structure such as a hull or frame and a floor, using a plurality of controllable fluid energy absorbers connected between the floor and base structure for attenuating forces transmitted there between as a function of a control signal applied to the energy absorber. The floor may be suspended or supported above the body, and in either case the energy absorber may be pre-biased by a spring or means of activating the controllable fluid. The energy absorbers may be attached in the manner of a Stewart platform: along the perimeter of the floor by ball-and-socket-joints to provide multi-axis damping. In another embodiment, the protective flooring system comprises a plurality of resilient bladders sandwiched between the floor and overlying tiles, each bladder being filled with controllable fluid in fluid communication with one or more flow valve(s) which can activate the controllable fluid to provide a controllable fluid damping characteristic.

### CROSS-REFERENCE TO RELATED APPLICATIONS

The present application derives priority from U.S. provisional patent application Ser. No. 62/189,778 filed on 8 Jul. 2015.

### BACKGROUND OF THE INVENTION

Field of the Invention

The present invention relates to a system for attenuating loads transmitted from a base to a supported payload.

Description of the Background

The mitigation of severe shock is a critical issue in military ground vehicle design. In recent conflicts, more than half of all casualties suffered by US coalition forces resulted from Improvised Explosive Devices (IEDs). Underbody blasts from IEDs result in significant axial loading to the lower limbs and spine, leading to devastating injuries. Isolated flooring systems using energy absorber (EA) technologies offer the potential for attenuating the loading from these blasts to help prevent such casualties. A key integration challenge for EA flooring systems, however, is the impact on vehicle packaging space and the resulting increase in vehicle size and weight. As such, providing such floor isolation while minimizing required packaging space and floor travel (stroke) is critical for vehicle design.

A primary driver for required floor travel in such isolation/suspension systems is the variance in supported mass and blast threats. With flooring systems in particular, the supported mass can vary widely depending upon size and number of occupants in the vehicle as well as other equipment loaded on the vehicle. Conventional passive EA technologies, such as composite crush tubes, wire benders, inversion tubes, hydraulic shock absorbers, etc., typically stroke at a fixed load profile. In order to limit peak acceleration transmitted to occupants supported by the floor, the magnitude of this fixed stroking load is typically tuned to bring the lightest mass condition to just within injury tolerance levels. Then, increasing mass from that point further lowers peak accelerations, but drives an increase in required stroking distance.

FIGS. 1-2 show a simple graphical example where an idealized fixed load EA (FLEA) is tuned to attenuate a 350G, 5 millisecond, triangular blast input pulse to just within injury tolerance levels for a 5th percentile female leg mass using just over 1 inch of stroke. With a fixed stroking load, an increase in mass to the 95th percentile male leg yields a 50% lower stroking acceleration (FIG. 1), however at the expense of nearly 3 inches of required floor travel to prevent hard bottom-out (FIG. 2). Significantly greater stroke would be required if the floor were expected to protect occupant extremities ranging from a single to multiple pairs of legs. Moreover, blast threat levels can also vary widely. With FLEAs, any increase in blast energy will yield a greater floor travel requirement. Finally, since FLEAs typically rely on plastic deformation of materials, they are single-use. As such, once the EA stroke is utilized in the initial vehicle liftoff from the blast, it is incapable of isolating the ensuing vehicle slam-down. In order to protect for this slam-down event, even further floor travel would be required. Therefore, isolated flooring systems utilizing passive EA technologies clearly canmot provide sufficient protection within the stroke objectives.

In order to minimize the required floor travel and meet requirements for vehicle integration, an adaptable EA flooring technology is required. Such a system would adapt its stroking load in real-time to a range of floor-supported masses and blast threat levels such that the stroking distance is minimized across all conditions. Such a system could reset and provide protection for the secondary vehicle slam-down and have the added capability of providing shock and vibration isolation during normal operation.

The use of EA flooring, however, is not limited to vehicle underbody blasts nor occupant protection. There are several other use cases for such a system, both vehicular and non-vehicular, including but not limited to attenuation of crash loads, shock and vibration during transit, seismic loading, etc. Protected payloads may be people/animals, structures, equipment, etc.

### SUMMARY OF THE INVENTION

It is, therefore, an object of the present invention to provide a system for attenuating load transferred from a base to a supported payload using a “smart” or controllable fluid, which for purposes of description is herein defined as a magnetorheological (MR) fluid, electrorheological (ER) fluid, or ferrofluid.

It is another object to provide a system as above wherein controllable fluid is utilized to create an adaptive energy absorber.

It is another object to provide a system as described above where the adaptive energy absorber using controllable fluid is adjusted based upon sensor measurements, such as supported weight/mass, accelerations, velocities, etc.

It is another object to provide a system where said adaptive energy absorber is controlled based upon sensor measurements to optimize load transmitted to payload within a minimized stroking distance.

It is another object to provide a system that can recover stroke utilized in an initial event for attenuation of a subsequent event.

It is another object to provide a system that can provide isolation of vehicle shock and vibrations to payload due to normal operations (i.e., vehicle travelling on/off road as opposed to extreme blast/shock loads).

According to the present invention, the above-described and other objects are accomplished by providing a protective flooring system for a vehicle having a “base structure” such as a hull or vehicle frame or structural extension thereof and a “payload interface” such as a vehicle floor. In one embodiment, a plurality of adaptive energy absorbers (AEAs) are connected between the payload interface and base structure for attenuating forces transmitted from the vehicle base structure to the payload as a function of a control signal applied to the AEAs, and thereby controlled damping of the payload interface. In an embodiment a vehicle floor may be suspended from the base structure by the AEAs, or supported above the base structure by the AEAs. In the latter case the AEAs may be pre-biased by a spring to a normally-extended position relative to the cylindrical housing, or by permanent magnet(s) inside the AEAs for generating a constant baseline magnetic field. The AEAs may be attached in the manner of a Stewart platform, at least two AEAs connected to each corner of the vehicle floor by a ball-and-socket-joint to provide multi-axis damping.

The AEAs using controllable fluid may be of several forms. They may be in the form of a linear stroking piston-type shock absorbers, similar in form factor to an automotive-type shock absorber as shown in Applicant's prior U.S. Pat. No. 7,878,312 issued 1 Feb. 2011. The AEAs may also be in the form of a rotary energy absorber, as shown in U.S. Pat. No. 8,424,656, wherein linear motion between the vehicle floor and base structure is converted into rotary motion via a mechanism such as a cable reel, mechanical gearing, helical screw, or linkage. A third form of AEA involves resilient bladders filled with a controllable fluid and in fluid communication with a fluid flow valve that activates the controllable fluid. When the vehicle floor/payload interface is compressed relative to the vehicle body/subfloor, pressure generated within the bladders causes fluid to flow through the fluid flow valve, creating a damping effect and attenuating the load transmitted from the vehicle body/subfloor to the vehicle floor/payload interface. A control signal applied to the fluid flow valve can activate the controllable fluid and modulate the pressure at which the fluid vents from the valve thereby also modulating the load attenuation levels.

### BRIEF DESCRIPTION OF THE DRAWINGS

Other objects, features, and advantages of the present invention will become more apparent from the following detailed description of the preferred embodiment and certain modifications thereof, in which:

FIG. 1 is a graph showing the effects of using an FLEA with varying male and female masses, charting floor acceleration (g) as a function of time (t).

FIG. 2 is a graph showing the effects of using an FLEA with varying male and female masses as in FIG. 1, charting floor travel (inches) as a function of time (t).

FIG. 3(A) is a perspective illustration of a suspension system for attenuating load transferred from a base to a supported payload using magnetorheological fluid according to a first embodiment of the invention, showing the AEAs fully contracted before a blast event. FIG. 3(B) is a perspective illustration of a suspension system for attenuating load transferred from a base to a supported payload as in FIG. 3(A), showing AEAs fully extended after the blast event.

FIG. 4(A) is a perspective illustration of an alternate embodiment of a system for attenuating load similar to the first embodiment except that the AEAs support the payload from below, and showing the AEAs fully extended before a blast event. FIG. 4(B) is a perspective illustration of the embodiment of FIG. 4(A), showing AEAs fully compressed after the blast event.

FIG. 5 is a perspective illustration of an alternate embodiment of a suspension system for attenuating load transferred from a base to a supported payload using a plurality of bladder-type AEAs sandwiched between the vehicle body/subfloor and the vehicle floor/payload interface. Each bladder-type AEA is filled with a controllable fluid, and all the bladders are in fluid communication with at least one fluid flow valve for controlling passage of the controllable fluid out of the resilient bladders, thereby providing a controlled fluid damping characteristic between the vehicle floor/payload interface and vehicle body/subfloor. The fluid exiting the fluid flow valve may be vented into ambient air, or into an accumulator as shown. In this illustration, the vehicle floor is separated into multiple tiles that can act independently.

FIG. 6 is a cut-away perspective view of the embodiment of FIG. 5 with enlarged inset showing an exemplary electronically controlled fluid flow valve for use with MR fluid.

FIG. 7 is a block diagram of a suitable sensor and control system 100 for use with any of the embodiments of FIGS. 3-6.

### DETAILED DESCRIPTION

The present invention is a system for attenuating load transferred from a base to a supported payload such as a floor, using “smart” or controllable fluids, such as magnetorheological (MR) fluid or electrorheological fluid, to provide optimal, full-spectrum survivability within a minimized stroking distance. MR technology is particularly attractive for this application because it offers an innovative and reliable way to achieve what is effectively a continuously adjustable energy absorber that can be electronically controlled based upon real-time environmental measurements. Not only will the present system, adapt in real-time to varying floor supported masses and blast threats, it will also: (a) recover stroke utilized in the initial blast for re-use in the vehicle slam-down, and (b) have the capability of providing semi-active ride control during normal vehicle operations to reduce occupant fatigue and increase mission effectiveness.

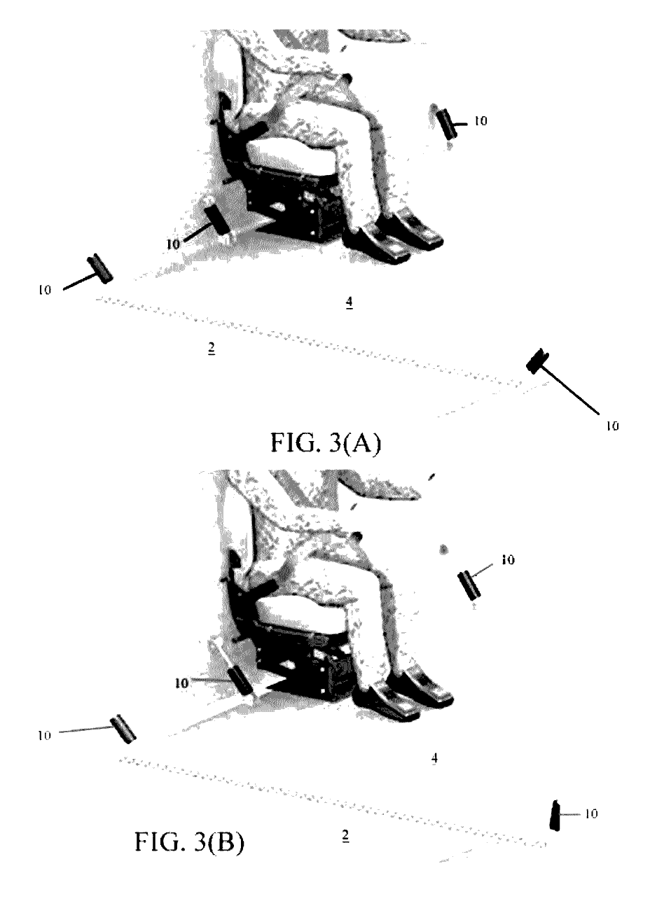

FIGS. 3(A), 3(B). 4(A), 4(B) and 5 collectively show three variations of the concept for how controllable fluid technology can be utilized for blast attenuating flooring. In all of these cases, and adaptive energy absorber (AEA) is operatively coupled between a “base structure” such as the hull of the vehicle 2 or extension thereof and a “payload interface” 4 such as the vehicle floor structure. The first two are variations of a Stewart platform in which adaptive energy absorbers (AEAs) 10 are pivotally attached between the hull of a vehicle 2 and a floor structure 4 to pro-vide multi-degree-of-freedom isolation (the degree of which is tailorable via geometry and pivot design). In these first two variations, the AEAs 10 may be linear stroking devices, similar in form factor to automotive shock absorbers as shown in Applicant's prior U.S. Pat. No. 7,878,312 issued 1 Feb. 2011, or they may be rotary devices that are operatively coupled, such as those shown in U.S. Pat. No. 8,424,656 combined with a linear-to-rotary motion conversion mechanism, such as, but not limited to a mechanical gearing, cable and reel, helical screw, or other mechanical linkage. These references are herein incorporated by reference in their entirety.

In the first embodiment of FIG. 3(A) and FIG. 3(B), the floor 4 is suspended from the hull 2 sidewalls via AEAs 10. FIG. 3(A) shows the AEAs in their fully contracted positions while FIG. 3(B) shows the AEAs fully extended.

In operation, the floor 4 and AEAs 10 are held in their fully contracted positions (FIG. 3(A) either by pre-biasing using spring elements or with permanent magnets in the AEA as shown in U.S. Pat. No. 9,109,654. In either case the pistons of the AEAs are held in their compact, contracted positions without requiring power input. Upon blast loading to the hull 2, the AEA 10 pre-bias/spring force is overcome and the floor 4 translates downward with respect to the hull 2, extending the controlled AEAs 10 as shown in FIG. 3(B).

The AEAs 10 may be arranged along the perimeter of the floor 4 and attached to the hull 2 and floor 4 by ball joints, thereby providing a limited degree of lateral and longitudinal motion for six-axis degree of freedom motion capability to attenuate oblique blast loading. If springs are used in combination with the AEAs 10, the system will have the capability of recoiling/resetting after vehicle liftoff in order to attenuate the ensuing slam-down. It would further have the capability of providing semi-active ride control for shock and vibration during normal vehicle operation.

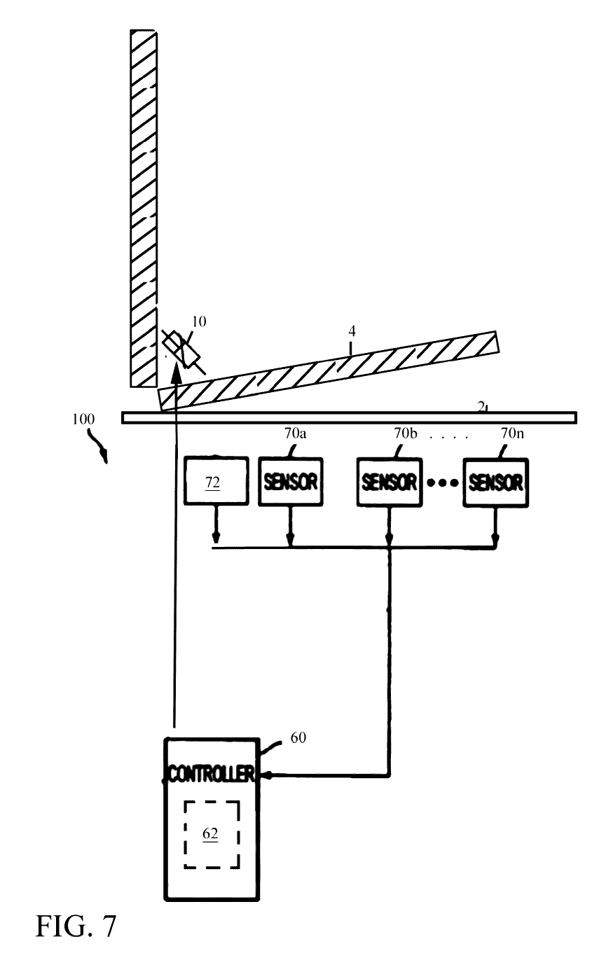

One skilled in the art will understand that the AEAs 10 are preferably adjusted based upon sensor measurements, such as supported weight/mass, accelerations, velocities, etc. The adjustments may be made to optimize load transmitted to payload within a minimized stroking distance, to recover stroke utilized in an initial event for attenuation of a subsequent event, to provide isolation of vehicle shock and vibrations to payload due to normal operations (i.e., vehicle travelling on/off road as opposed to extreme blast/shock loads), or otherwise as a matter of design choice. FIG. 7 (described below) is a block diagram of a suitable sensor and control system 100.

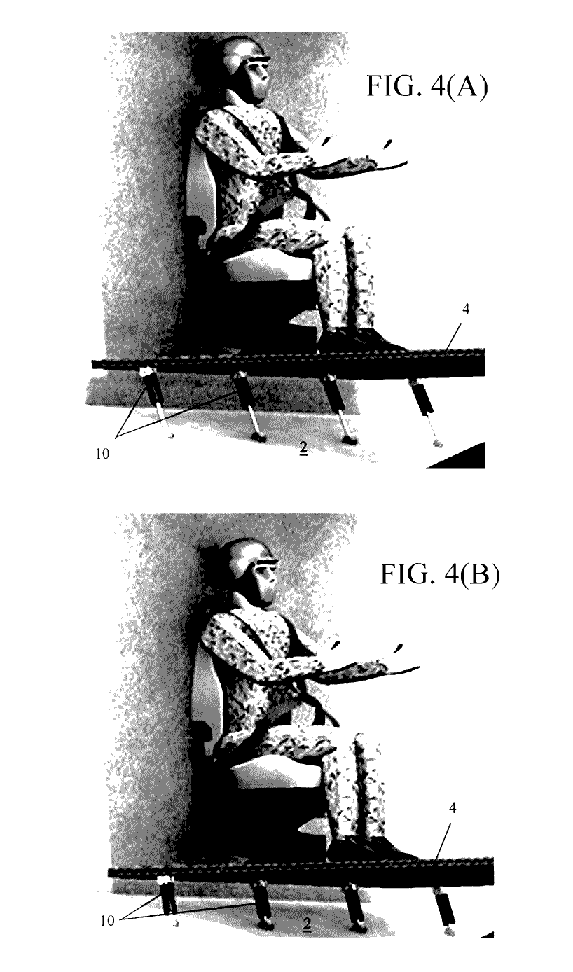

FIGS. 4(A) and 4(B) show a second embodiment better-suited for a vehicle configuration where there is space available under the floor, for instance between a V-shaped hull 2 and floor 4. In this configuration, the AEAs 10 initially remain in their extended configuration (again, held by spring elements or permanent magnets in AEAs 10) prior to blast and are compressed during blast (FIG. 4(B)). This configuration has the same capability as that of FIGS. 3(A, B), and may likewise be configured for attenuating oblique blast loading through ball joint connections, as well as capabilities to reset for vehicle slam-down and provide semi-active ride control during normal vehicle operation.

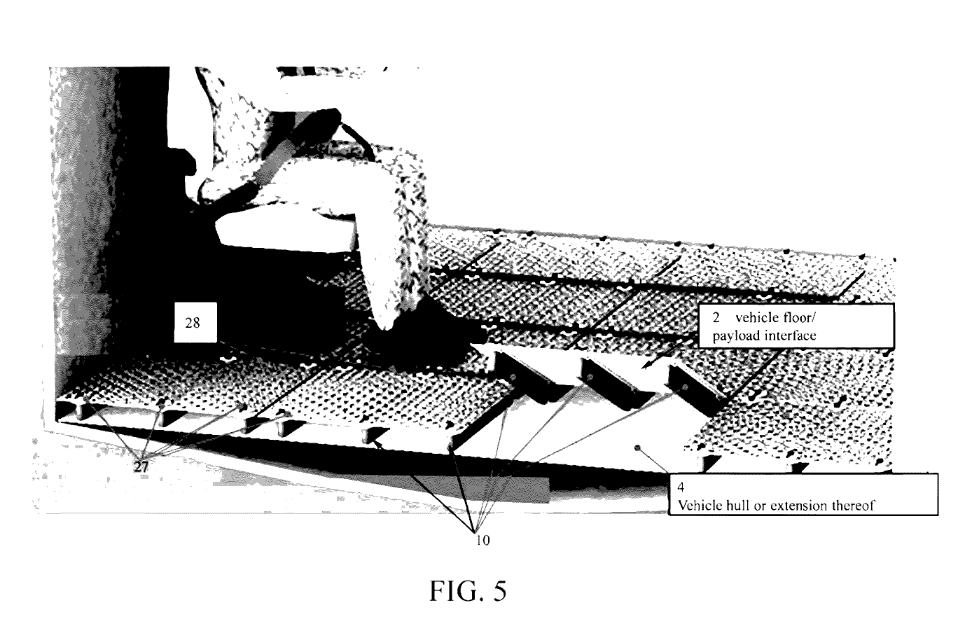

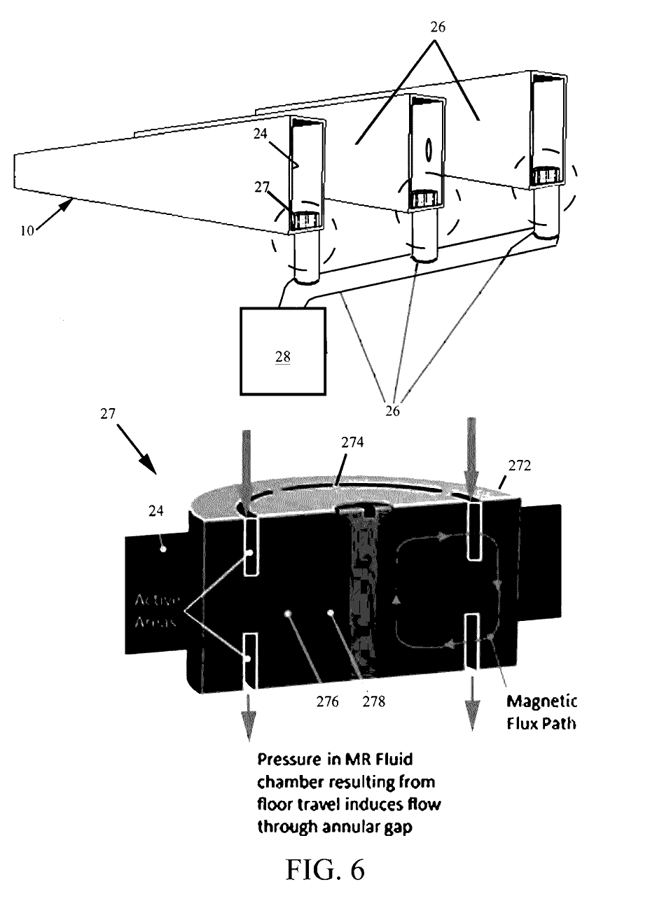

FIG. 5 illustrates a third embodiment in which a plurality of bladder-type AEAs 10 are sandwiched between the vehicle bull 4 or extension thereof and vehicle floor 2. The bladder-type AEAs 10 are soft-walled closed resilient chambers/bladders 24 filled in fluid communication with a fluid flow valve 27 that activates the controllable fluid to modulate flow out of the valve. The bladders 24 are filled with the controllable fluid under low pressure and provide compressible structural support to the flooring system. Upon blast loading the vehicle hull 4, shearing (oblique loading) and compression (vertical loading) forces are transmitted through the beam-shaped bladders 24 to the vehicle floor 2 and payload there atop, which causes the fluid to flow through one or more electronically controlled fluid flow valves 27 that adjusts the flow, and thus the load-stroke profile, in real-time. The outlet of the fluid flow valves 27 may be vented to ambient air or may be in fluid communication with an accumulator 28, and this may be accomplished by use of conduits 26 as shown in FIG. 6.

FIG. 6 is a cut-away perspective view of the embodiment of FIG. 5 with enlarged inset showing an exemplary electronically controlled fluid flow valve 27 for use with MR fluid. After exiting the fluid flow valve 27, the fluid may flow into an accumulator 28.

As seen in the FIG. 6 inset, the fluid flow valve 27 configuration for use with MR fluid includes a valve body 272 defined as a cylindrical segment with an annular flow gap 274 through body 272. The valve 27 includes a doughnut-shaped permanent magnet 278 surrounded by a coil 279. In this configuration, all MR fluids traveling through the valve 27 must flow through the annular gap 274. As the MR fluid is pushed from the bladders 24 through the flow gap 274 due to blast loading, the MR fluid flowing through the annular gap 274 will be affected by a magnetic field generated by the combined permanent magnet 276 and magnetic coil 278, and flow resistance can be regulated as required by controlling input current to the magnetic coil 278. As above, the permanent magnet 276 activates the MR fluid yield force without supplied electrical power to coil 278, and thus prevents fluid flow out of the beam-shaped bladders 24 until a tuned load threshold is reached. This threshold can then be electronically adjusted up or down by charging the adjacent electromagnetic coil 278 to increase or decrease the magnetic field in the active areas of the annular flow gap in the valve 27.

The embodiment of FIG. 5 may be employed as a single flooring interface or may be divided into multiple, independently acting flooring tiles as shown. This tiled flooring approach offers the ability to independently act and adapt to the individual mass that each floor section 2 is supporting (i.e., feet, seat, etc.).

In all of these embodiments, the AEA 10 may be adjusted based upon sensor measurements, such as supported weight/mass, accelerations, velocities, etc. Sensor measurements may be used to generate a control signal to the AEA, either through analog manipulation of sensor feedback or through a digital microprocessor. By doing so, the AEA may be controlled based upon sensor measurements to optimize load transmitted to payload within a minimized stroking distance. Such a system may not only attenuate extreme shock events, such as underbody blast loading, but also provide isolation of vehicle shock and vibrations resulting from normal operations (i.e., vehicle travelling on/off road as opposed to extreme blast/shock loads).

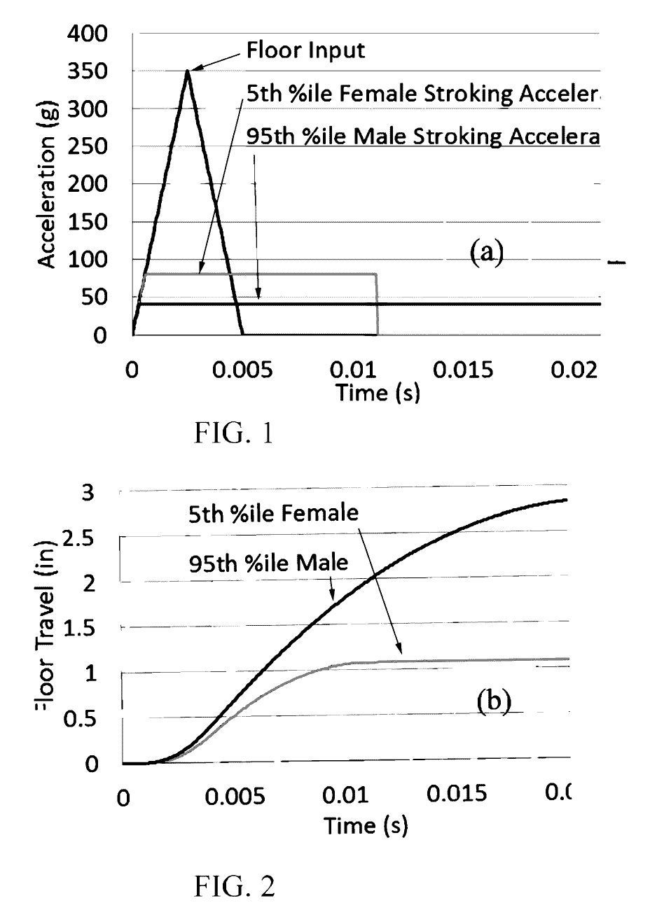

FIG. 7 is a block diagram of a suitable sensor and control system 100. A programmable controller 60 is in communication with each AEA 10. Controller 60 includes memory for storing and running control software 62 that automatically adjusts the AEAs 10 in real-time to an optimal setting based on feedback from one or more sensors (70 a, 70 b, . . . 70 n) and an optional payload weight indication mechanism 72. One or more sensors (70a, 70b, . . . 70n) may be used to trigger the controller 60 to execute a predefined control algorithm for generating control signals to the AEA 10. Controller 60 and control software 62 may also process the sensor data to determine the severity of the shock event and use this information to modify the predefined control algorithm for generating control signal to the AEA. One skilled in the art should understand that a single controller 60 may be used to control multiple AEA 30—equipped seats 20 as depicted in FIG. 1, or each AEA 10 may be individually controlled by its own controller 60. Controller 60 may comprise a processor, as well as a memory for storing control software 62 for execution by the processor. Based on processing performed, controller 60 interfaces with, and generates one or more control signals (controller outputs) to control AEAs 10. At a minimum, at least one sensor 70a is provided for triggering the execution of the control algorithm. Sensor 70a or an additional sensor 70b may also derive a shock severity measurement that may be an acceleration, velocity, force, or pressure. The shock severity may be measured by the adaptive energy absorption system 100 in a number of different ways. For vehicles moving horizontally (transverse to gravity) such a measurement may be made by the existing vehicle's speedometer or a tachometer. Alternatively an aircraft's airspeed indicator andkIor altimeter may be leveraged by the adaptive control system 100. In a preferred embodiment of the control system 100, sensor 70a comprises an accelerometer and shock severity is derived from the accelerometer measurements. However, other sensors 70b-n may measure force (e.g, a load cell), velocity (e.g., PVT, etc.), strain/displacement (e.g., LVDT, strain gauge, etc), pressure (pressure transducer). Moreover, sensors 70b-n may comprise an existing vehicle sensor (for example, an aircraft altimeter to measure sink rate, or a vehicle speedometer or tachometer). Sensor 70 a may be mounted on or proximate the floor 4, or on a platform or other structure to which, floor 4 may operatively connected. It should now be apparent that the present invention provides an effective system for attenuating load transferred from any base to a supported payload by use of a “smart” or controllable fluid such as magnetorheological fluid, electrorheological fluid, or ferrofluid.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

We claim:

1. A protective system for attenuating loads transmitted from a base structure to a payload supported by said base structure, comprising:
a payload interface attached to said payload; and
a plurality of adaptive energy absorbers each connected between said payload interface and said base structure, each adaptive energy absorber further comprising,
a housing defining a sealed interior,
a controllable fluid within the interior of said housing,
means for activating said controllable fluid to affect performance of at least one of said adaptive energy absorbers;
whereby forces transmitted from the base structure to the payload interface and payload may be selectively attenuated as a function of control signals applied to said adaptive energy absorbers.

2. The protective system according to claim 1, wherein said controllable fluid is one of magnetorheological fluid, electrorheological fluid, or ferrofluid.

3. The protective system according to claim 1, wherein said payload interface comprises a vehicle floor suspended from a vehicle base structure by said plurality of adaptive energy absorbers.

4. The protective system according to claim 3, wherein said vehicle floor is substantially polygonal and said plurality of adaptive energy absorbers comprise at least one adaptive energy absorbers connected along the perimeter of said vehicle floor.

5. The protective system according to claim 1, wherein each of said plurality of adaptive energy absorbers is connected to said payload interface by any one of a pivot-joint or a ball-and-socket joint.

6. The protective system according to claim 1, wherein said payload interface comprises a vehicle floor supported above a vehicle base structure by said plurality of adaptive energy absorbers.

7. The protective system according to claim 1, further comprising a spring for pre-biasing system in an upward or unstroked position.

8. The protective system according to claim 1, wherein at least one of said plurality of adaptive energy absorbers further comprises at least one permanent magnet attached inside said housing for generating a constant baseline magnetic field in said magnetorheological fluid for activating said magnetorheological fluid in the absence of a control signal.

9. The protective system according to claim 3, further comprising a plurality of AEAs connected between the perimeter of said vehicle floor and said vehicle base structure.

10. The protective system according to claim 1, wherein said plurality of AEAs are comprised of at least one linear stroking, piston-type AEA.

11. The protective system according to claim 1, wherein said plurality of AEAs are comprised of at least one rotary-type AEA connected to a mechanism for converting linear motion to rotation.

12. The protective system according to claim 1, wherein said plurality of AEAs are comprised of at least one bladder-type AEA further comprising,
a resilient bladder filled with controllable fluid, and
at least one fluid flow valve in fluid communication with said bladder,
whereby said forces transmitted from the base structure to said payload interface increase pressure of said fluid within said bladder thereby inducing said fluid to flow through said valve

13. The protective system according to claim 12, wherein said fluid flow valve can activate controllable fluid such that the pressure required to induce said fluid to flow through said valve is modulated.

14. The protective system according to claim 12, wherein an exit of said fluid flow valve is in fluid communication with an accumulator for storing said fluid expelled from said bladder.

15. The protective system according to claim 12, wherein said plurality of resilient bladders each comprise a hollow elongate beam-shaped bladder.

16. The protective system according to claim 15, wherein each of said beam-shaped bladders are substantially rectangular.

17. The protective system according to claim 12, wherein said fluid flow valve comprises a valve body configured with a flow path.

18. The protective system according to claim 17, wherein said fluid flow valve comprises a flow path through said valve body.

19. The protective system according to claim 18, wherein said fluid flow valve comprises an electromagnetic coil adjacent to said flow path.

20. The protective system according to claim 12, further comprising at least one permanent magnet contained within or adjacent to said fluid flow valve.

21. The protective system according to claim 1, wherein said control signals are determined from signals measured by a plurality of sensors.

22. The protective system according to claim 21, wherein one of said sensors is one of an accelerometer, force transducer, displacement sensor, strain gage, or pressure gage.

23. The protective system according to claim 21, wherein one of said sensors measures one of an acceleration, velocity, displacement, force, or pressure of or on the base structure or vehicle floor.

24. The protective system according to claim 21, wherein one of said sensors measures weight supported by the vehicle floor.

25. The protective system according to claim 21, wherein said control signals are analog manipulations of said sensor signals.

26. The protective system according to claim 21, further comprising a processor for generating control signals based upon said sensor signals.

27. The protective flooring system according to claim 21, further comprising a processor configured to generate predetermined control signals based upon one or more of said sensor signals.
